(19) United States
(12) Patent Application Publication
(10) Pub. No.: US 2008/0026821 A1
(43) Pub. Date: Jan. 31, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/585,128

(22) Filed: Oct. 24, 2006

Related U.S. Application Data
(60) Provisional application No. 60/833,252, filed on Jul. 26, 2006.

(51) Int. Cl. G07F 17/32

(52) U.S. Cl. 463/20

(57) ABSTRACT

In a slot machine according to the present invention, all symbols arranged on a display are formed from scatter symbols. Further, if desired credits are betted by, for example, inserting coins therein, a type of symbols which corresponds to the number of BETs is made effective. For example, if the number of BETs is 1, “CHERRY” is made effective, while if the number of BETs is 2, “BELL is made effective. Further, when the plurality of symbols arranged on the display are automatically rearranged, game media are paid out, according to the number of scatter symbols of the type which has been made effective displayed on the display. For example, when “CHERRY” has been made effective, if three “CHERRY” are displayed on the display, then two coins which corresponds to the three “CHERRY” are paid out.

### CROSS-REFERENCE TO RELATED APPLICATIONS

This application claims priority of U.S. Provisional Application No. 60/833,252 filed on Jul. 26, 2006. The contents of this application are incorporated herein by reference in their entirety.

### BACKGROUND OF THE INVENTION

1. Field of the Invention

The present invention relates to a slot machine and a playing method thereof.

2. Discussion of the Background

In a conventional slot machine, if a player inserts game media such as coins or bills into an insertion slot and pushes a spin button, then a plurality of symbols are displayed in a scrolling manner on a display provided on the front surface of a casing and, thereafter, the respective symbols are automatically stopped.

In such a slot machine, if a predetermined combination of symbols are stop-displayed along a winning line, then a predetermined number of game media are paid out, as disclosed in, for example, U.S. Pat. No. 6,604,999 and US 2002-0065124-A1. Further, a predetermined number of game media are paid out, according to the number of specific symbols, called scatter symbols, displayed on the display, regardless of the winning line. Namely, a conventional slot machine pays out game media according to a combination of two types of methods.

The present invention provides a slot machine and a playing method thereof which have entertainment characteristics which have not been offered by the aforementioned conventional art.

The contents of U.S. Pat. No. 6,604,999 and US 2002-0065124-A1 are incorporated herein by reference in their entirety.

### SUMMARY OF THE INVENTION

A first aspect of the present invention is a slot machine including: a display to which a plurality of symbols are arranged; and a controller which conducts a direct or an indirect paying out of a game medium, according to the number of scatter symbols displayed to said display, when the plurality of symbols arranged to said display are automatically rearranged, wherein said scatter symbol is any type of symbols which are to be arranged.

A second aspect of the present invention is a slot machine including: a display to which a plurality of symbols are arranged; an arrangement controller which conducts control for automatically rearranging the plurality of symbols arranged to said display; an effectiveness-setting controller which conducts control for making effective a type of scatter symbol which corresponds to the number of BETs, out of a plurality of types of scatter symbols; and a payout controller which conducts control for conducting a direct or an indirect paying out of a game medium according to the number the type of effective scatter symbols displayed to said display, when said arrangement controller rearranges the symbols, wherein said scatter symbol is any type of symbols which are to be arranged.

A third aspect of the present invention is a slot machine including: a display to which a plurality of symbols are arranged; an arrangement controller which conducts control for automatically rearranging the plurality of symbols arranged to said display; an effectiveness-setting controller which conducts control for increasing the number of types of scatter symbols that are made effective out of a plurality of types of scatter symbols, along with an increase in the number of BETs; and a payout controller which conducts control of a direct or an indirect paying out of a game medium according to the number of scatter symbols of the type made effective, displayed to said display, when said arrangement controller rearranges the symbols, wherein said scatter symbol is any type of symbols which are to be arranged.

A fourth aspect of the present invention is a slot machine including: a display to which a symbol matrix formed by a plurality of columns and a plurality of rows is arranged; an arrangement controller which conducts arrangement control for selecting symbols from a plurality of types of symbols to determine the symbols to be arranged in said symbol matrix and stopping a state of scrolling at the position of the determined symbols, in order to rearrange a plurality of symbols arranged to said display as a new symbol matrix after scrolling of the plurality of symbols; an effectiveness-setting controller which conducts control for making effective a type of scatter symbol which corresponds to the number of BETs, out of a plurality of types of scatter symbols; and a payout controller which conducts control for conducting a direct or an indirect paying out of a game medium according to the number of scatter symbols of the type made effective, displayed to said display, when the symbol matrix is rearranged after the scrolling thereof in said display, wherein said scatter symbol is any type of symbols which are to be arranged.

A fifth aspect of the present invention is a slot machine including: a display to which a symbol matrix formed by a plurality of columns and a plurality of rows is arranged; an arrangement controller which, in order to rearrange a plurality of symbols arranged to said display as a new symbol matrix after scrolling of the plurality of symbols, conducts arrangement control for selecting symbols from a plurality of types of symbols, determining the selected symbols as the symbols to be arranged in said symbol matrix and stopping the scrolling such that the determined symbols are stop-displayed; an effectiveness-setting controller which conducts control for increasing the number of types of scatter symbols, out of a plurality of types of scatter symbols, which are made effective, with increasing number of betted credits; and a payout controller which directly or indirectly pays out game media according to the number of scatter symbols of the type which has been made effective displayed to said display, when the symbol matrix is rearranged after the scrolling thereof in said display, wherein said scatter symbol is any type of symbols which are to be arranged.

A sixth aspect of the present invention is a playing method of a slot machine comprising a step of conducting a direct or an indirect paying out of a game medium according to the number of scatter symbols displayed to a display when a plurality of symbols arranged to said display are automatically rearranged, wherein said scatter symbol is any type of symbols which are to be arranged.

A seventh aspect of the present invention is a playing method of a slot machine comprising the step of: rearranging automatically a plurality of symbols arranged to a display; making a type of scatter symbols which corresponds to the number of BETs, out of a plurality of types of scatter symbols, effective; and paying out a game medium directly or indirectly, according to the number of scatter symbols of the type made effective, displayed to said display, when the symbols are rearranged, wherein said scatter symbol is any type of symbols which are to be arranged.

An eighth aspect of the present invention is a playing method of a slot machine comprising the step of: rearranging automatically a plurality of symbols arranged to a display; increasing the number of types of scatter symbols, out of a plurality of types of scatter symbols, which are made effective, with increasing number of betted credits; and paying out a game medium directly or indirectly, according to the number of scatter symbols of the type made effective, displayed to said display, when the symbols are rearranged, wherein said scatter symbol is any type of symbols which are to be arranged.

A ninth aspect of the present invention is a playing method of a slot machine which repeats a unit game that is started by starting scrolling display of a plurality of symbols arranged to a display and is completed by stopping the scrolling display to rearrange said plurality of symbols, comprising the step of: stopping automatically said scrolling display of the symbols; making a type of scatter symbols which corresponds to the number of BETs, out of a plurality of types of scatter symbols, effective; and paying out a game medium directly or indirectly, according to the number of scatter symbols of the type made effective, displayed to said display, when the scrolling display of the symbols are automatically stopped, wherein said scatter symbol is any type of symbols which are to be arranged.

A tenth aspect of the present invention is a playing method of a slot machine which repeats a unit game that is started by starting scrolling display of a plurality of symbols arranged to a display and is completed by stopping the scrolling display to rearrange said plurality of symbols, comprising the step of: stopping automatically the scrolling display of the symbols; increasing the number of types of scatter symbols, out of a plurality of types of scatter symbols, which are made effective, with increasing number of betted credits; and paying out game media directly or indirectly, according to the number of scatter symbols of the type made effective, displayed to said display, when the scrolling display of the symbols are automatically stopped, wherein said scatter symbol is any type of symbols which are to be arranged.

### BRIEF DESCRIPTION OF THE DRAWINGS

FIG. 1 is an example of scatter symbols arranged on a lower image display panel in a slot machine according to an embodiment of the present invention;

FIG. 2 is a perspective view illustrating an appearance of the slot machine according to the embodiment of the present invention;

FIG. 3 is a schematic view illustrating symbol rows drawn on the outer peripheral surfaces of respective reels;

FIG. 4 is a block diagram illustrating an internal structure of the slot machine illustrated in FIG. 2;

FIG. 5 is a flow chart illustrating a subroutine of game executing processing;

FIG. 6 is a view illustrating relationship between the number of BETs and corresponding types of symbols which are made effective;

FIGS. 7A to 7C are views illustrating exemplary images displayed on an upper image display panel;

FIG. 8 is a flow chart illustrating a subroutine of symbol determination processing;

FIG. 9 is a view illustrating relationship between plural types of prizes and corresponding number of coins to be paid out;

FIG. 10 is an example of scatter symbols arranged on the lower image display panel in the slot machine; and

FIG. 11 is a flowchart illustrating a subroutine of bonus game processing.

### DESCRIPTION OF THE EMBODIMENTS

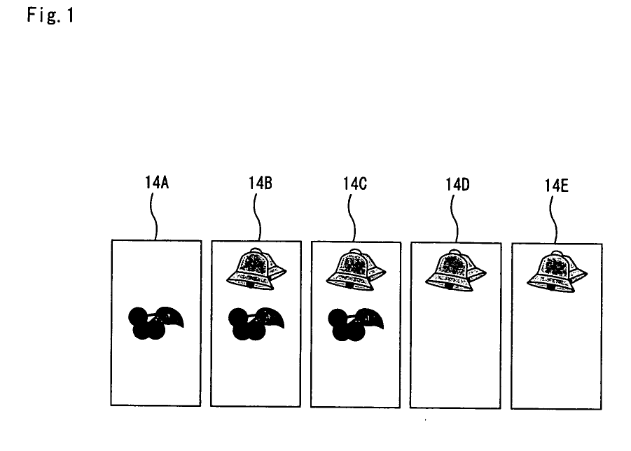

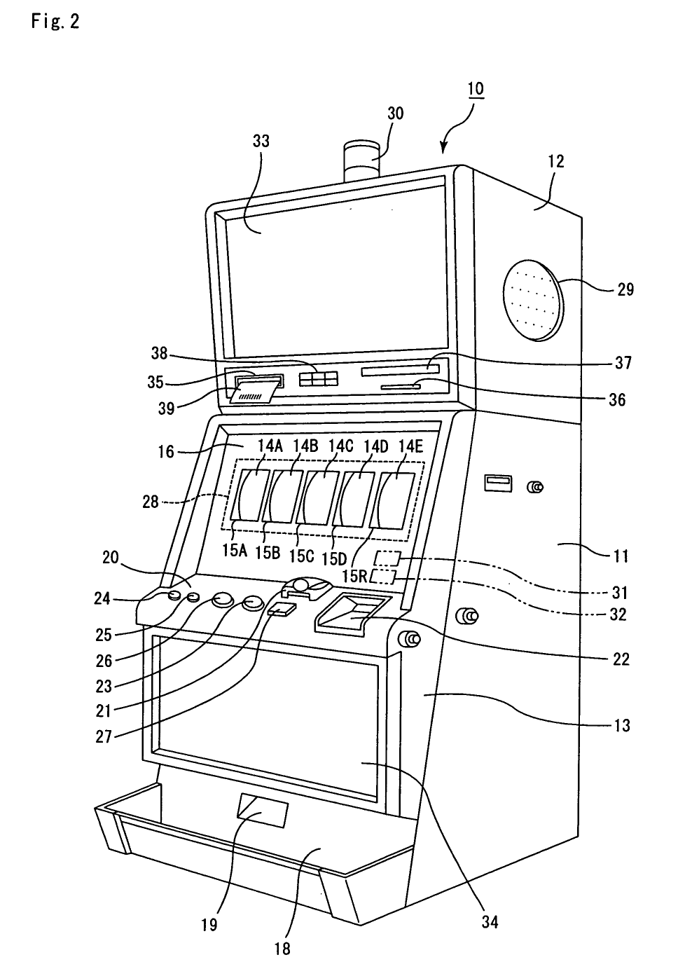

FIG. 1 is a view illustrating an example of scatter symbols arranged on a lower image display panel in a slot machine according to an embodiment of the present invention. FIG. 2 is a perspective view illustrating an appearance of the slot machine according to the embodiment of the present invention.

The slot machine 10 according to the present invention has symbols of plural types, and all the symbols are constituted by scatter symbols. The scatter symbols are symbols as follows. That is, if a predetermined number or more of scatter symbols of the same type are displayed (arranged) in a symbol display region 28 in a lower image display panel 16 (display) at the time of rearrangement, this means the occurrence of winning, thereby offering allotment to the player. Since all the symbols are scatter symbols in the present invention, the scatter symbols will also be simply referred to as symbols, in the following description.

First, if a desired number of credits are betted by, for example, inserting coins into a coin receiving port 21 in the slot machine 10, then scatter symbols of the type corresponding to the number of BETs are made effective. For example, if the number of betted credit is 1, “CHERRY” is made effective, while if the number of BETs is 2, “BELL” is made effective.

If a spin button 23 is pushed in this state, this causes reels 14 (14A, 14B, 14C, 14D and 14E) provided behind display windows 15 (15A, 15B, 15C, 15D and 15E) to rotate, and the symbols start scrolling. The display windows 15 are provided on a front surface of a cabinet 11 along five columns and three rows. Thereafter, the scrolling is stopped to stop (rearrange) a total of 15 symbols along five columns and three rows.

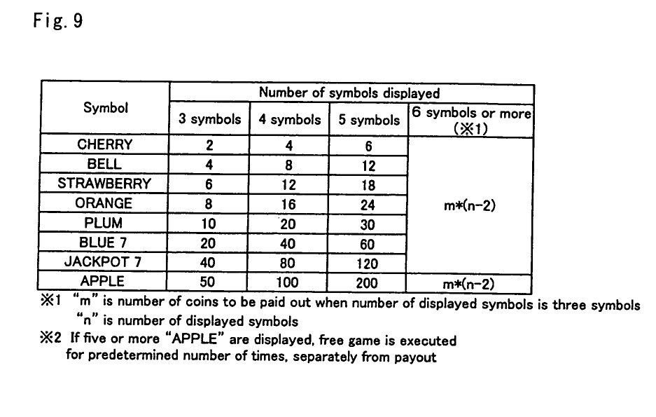

FIG. 1 illustrates a state where three “CHERRY” and four “BELL” are stop-displayed. The slot machine 10 counts the number of symbols of the effective type displayed in the symbol display region 28 and pays out a number of coins which corresponds to the number of counted effective symbols. For example, when “CHERRY” has been made effective, the slot machine 10 pays out two coins, which corresponds to the three “CHERRY” displayed therein (see FIG. 9), while when “BELL” has been made effective, the slot machine 10 pays out 8 coins, which corresponds to the four “BELL” displayed therein (see FIG. 9).

There has been described a case where a single type of symbols which corresponds to the number of BETs is made effective, in the aforementioned example. However, the present invention is not limited thereto, and the number of types of symbols to be made effective can be increased with increasing number of betted credits. For example, if the number of BETs is 1, “CHERRY” can be made effective, while if the number of BETs is 2, “CHERRY” and “BELL” can be made effective. In the case of configuring the slot machine 10 to increase the number of types of symbols to be made effective with increasing number of betted credits, the slot machine 10 can pay out a number of coins which corresponds to the sum of the allotments for the respective types of symbols. For example, if three “CHERRY” and four “BELL” are displayed in the symbol display region 28 at the time of rearrangement of symbols, the slot machine 10 can pay out the sum (10 coins) of the allotment for the three “CHERRY” (two coins) and the allotment for the four “BELL” (8 coins).

While there has been described a case where symbols are displayed in the symbol display region 28 in the lower image display panel 16 (display) in the aforementioned example, the present invention is not limited thereto, provided that symbols are displayed (rearranged) on the display. Further, while there has been described a case where a total of 15 symbols along five columns and three rows are displayed in the aforementioned example, the present invention is not limited to cases where symbols are displayed along five columns and three rows. Further, while there has been described a case where the mechanical reels 14 are used to arrange symbols in the aforementioned example, a liquid crystal display device or the like can be also used to arrange symbols, in the present invention. Also, in the case of using a liquid crystal display device, for example, symbols can be displayed thereon in such a manner that they are scrolled in the upward or downward direction along the respective columns or individual symbols can be alternately displayed thereon.

Next, description will be given of construction of slot machine 10.

In the slot machine 10, a coin, a note or an electronic valuable information corresponding thereto is used as a game media. In the present invention, however, the game media is not particularly limited, and for example, a medal, a token, an electronic money and a ticket can be used. The ticket is not particularly limited and may include, for example, a ticket with a bar code as described later, and of the like tickets.

The slot machine 10 includes: a cabinet 11; a top box 12 placed on the upper side of the cabinet 11; and a main door 13 provided at the front face of the cabinet 11. Inside the cabinet 11, five reels 14 (14A, 14B, 14C, 14D and 14E) are rotatably installed. Twenty two designs (hereinafter, also referred to as symbols) are depicted as symbol sequences on the outer circumferential surface of each of the reels 14.

The lower image display panel 16 as a display is provided on the main door 13 in front of the reels 14. The lower image display panel 16 includes a transparent liquid crystal display panel which, during games, displays various types of information and effect images and the like relating to the games.

In the lower image display panel 16, there are provided a number-of-credits display section 31 and a number-of-payouts display section 32. The number-of-credits display section 31 displays an image indicating the number of credited coins. The number-of-payouts display section 32 displays an image indicating the number of coins to be paid out, in the event that a predetermined number of or more symbols of the effective type are stop-displayed in the symbol display region 28.

At the center portion of the lower image display panel 16, there is provided the symbol display region 28 for displaying symbols. Provided on the symbol display region 28 are the five display windows 15 (15A, 15B, 15C, 15D and 15E) through which aback surface of the symbol display region 28 can be seen. Three of the symbols drawn on an outer peripheral surface of each of the reels 14 are displayed through the corresponding display windows 15, respectively. If a predetermined number (three, in the present embodiment) of or more symbols of the effective type are stop-displayed in the symbol display region 28, then the number of coins corresponding to the number of the effective symbols displayed thereon are paid out.

A touch panel 69, which is not shown in the figure, is provided on the front face of the lower image display panel 16 and the player can input various kinds of commands by operating the touch panel 69.

Provided below the lower image display panel 16 are: a control panel 20 constituting of plural buttons 23 to 27 which are input by the player, commands associated with progress of the game; a coin receiving slot 21 accepting coins into the cabinet 11; and a Bill validator 22.

The control panel 20 is provided with: a spin button 23; a change button 24; a CASHOUT button 25; a 1-BET button 26; and a maximum BET button 27. The spin button 23 is used for inputting a command to start the rotating of the reels 14. The change button 24 is used in a case where a player requests an attendant of a recreation facility to exchange money. The CASHOUT button 25 is used for inputting a command to pay out credited coins to a coin tray 18.

The 1-BET button 26 is used for inputting a command to bet one coin of the credited coins. The maximum BET button 27 is used for inputting a command to bet the maximum number of coins that can be bet on one game (10 coins in the present embodiment) of the credited coins.

In the present invention, insertion of a game media means that a game media is bet on a game. For example, when coins inserted into the coin receiving slot 21 are directly bet on a game, insertion of coins into the coin receiving slot 21 corresponds to insertion of a game media. However, when coins inserted into the coin receiving slot 21 are temporarily credited, and the credited coins are bet on a game by operating the 1-BET button 26 or the maximum BET button 27, as in the present embodiment, the bet of the credited coins on the game corresponds to insertion of a game media.

The Bill validator 22 is used not only for discriminating a false note from a true note but also for accepting the true note into the cabinet 11. The Bill validator 22 maybe configured such that a ticket 39 with a bar code which will be described later can be read. A belly glass 34 on which characters and the like of the slot machine 10 are depicted is provided on the front face of the lower portion of the main door 13, that is, below the control panel 20.

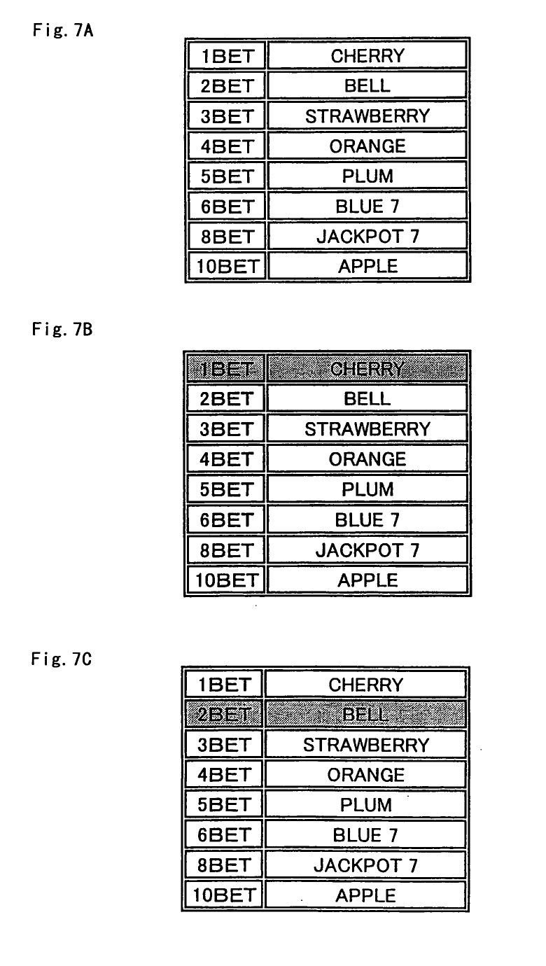

On a front surface of the top box 12, an upper image display panel 33 is provided. The upper image display panel 33 includes a liquid crystal display panel which displays, for example, images introducing the contents of games and explaining the rules of games. Further, the upper image display panel 33 displays an image indicating the type of symbols which has been made effective according to the number of BETs (see FIGS. 7A to 7C)

A speaker 29 is provided in the top box 12. A ticket printer 35, a card reader 36, a data display 37 and a key pad 38 are provided beneath the upper image display panel 33. The ticket printer 35 prints on a ticket a bar code in which data such as the number of credits, date, time, identification number of the slot machine 10 and of the like data are encoded, and outputs the ticket 39 with a bar code. A player can make the ticket 39 with a bar code to be read by a second gaming machine and play a game in the second gaming machine, or exchange in a predetermined place (for example, at a cashier in the casino) of a recreation facility the ticket 39 with a bar code to notes.

The card reader 36 is used for reading data from a smart card and writing data onto a smart card. The smart card is a card to be carried by a player, and for example, data to identify a player and data concerning a history of a game played by a player are stored thereon. Data corresponding to a coin, a note or a credit may also be stored on the smart card. As an alternative of a smart card, a magnetic stripe card may be adopted. The data display 37 is a fluorescent display and the like, and it is used, for example, to display data read by the card reader 36 and data input by a player from the key pad 38. The key pad 38 is used for inputting a command or data to issue a ticket and the like.

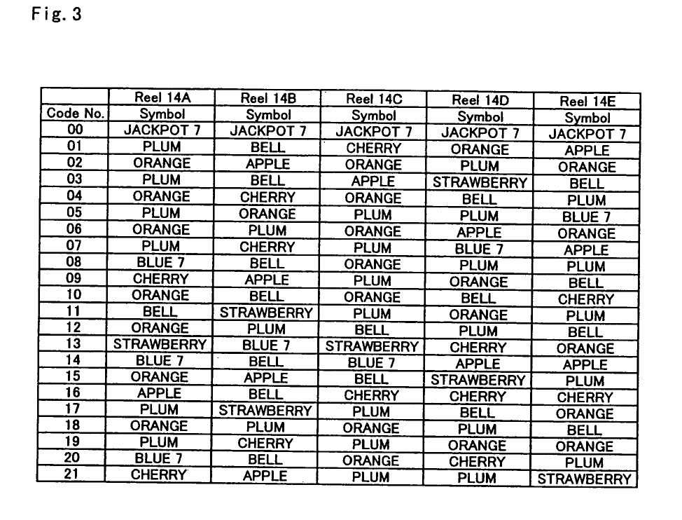

FIG. 3 is a schematic view showing the symbol sequence depicted on the outer circumferential surface of each reel.

Twenty two symbols each are depicted on the outer circumferential surface of the reel 14A, the reel 14B, the reel 14C, the reel 14D and the reel 14E. A sequence of the symbols depicted on the outer circumferential surface of each of the reels 14 is different from one another. The sequences of the symbols are combinations of the following symbols: “JACKPOT 7”, “BLUE 7”, “BELL”, “CHERRY”, “STRAWBERRY”, “PLUM”, “ORANGE” and “APPLE”.

If three or more of “JACKPOT 7”, “BLUE 7”, “BELL”, “CHERRY”, “STRAWBERRY”, “PLUM” or “ORANGE” are stop-displayed in the symbol display region 28, then a predetermined number of credits corresponding to the number of these displayed symbols are added to the player's credits (see FIG. 9).

The “APPLE” is a bonus game trigger (a symbol which causes transition to a bonus game). If five or more “APPLE” are stop-displayed in the symbol display region 28, a gaming state shifts to a bonus game. In the present embodiment, a bonus game is a free game (a game in which a predetermined number thereof can be played without inserting coins for BET).

When the spin button 23 is pushed after the 1-BET button 26 or the maximum-BET button 27 is pushed, a game starts and the symbol rows drawn on the respective reels 14 are displayed in such a manner that they are scrolled in the up-to-down direction, through the display windows 15, along with the rotation of the reels 14. After the elapse of a predetermined time period, the symbol rows are stop-displayed through the display windows 15, along with the stop of the rotation of the reels 14. Further, the number of coins to be paid out has been determined beforehand on the basis of the number of effective symbols displayed in the symbol display region 28 (see FIG. 9), and if a predetermined number or more of symbols of the same type are statically displayed, then the number of coins to be paid out is added to the player's credits.

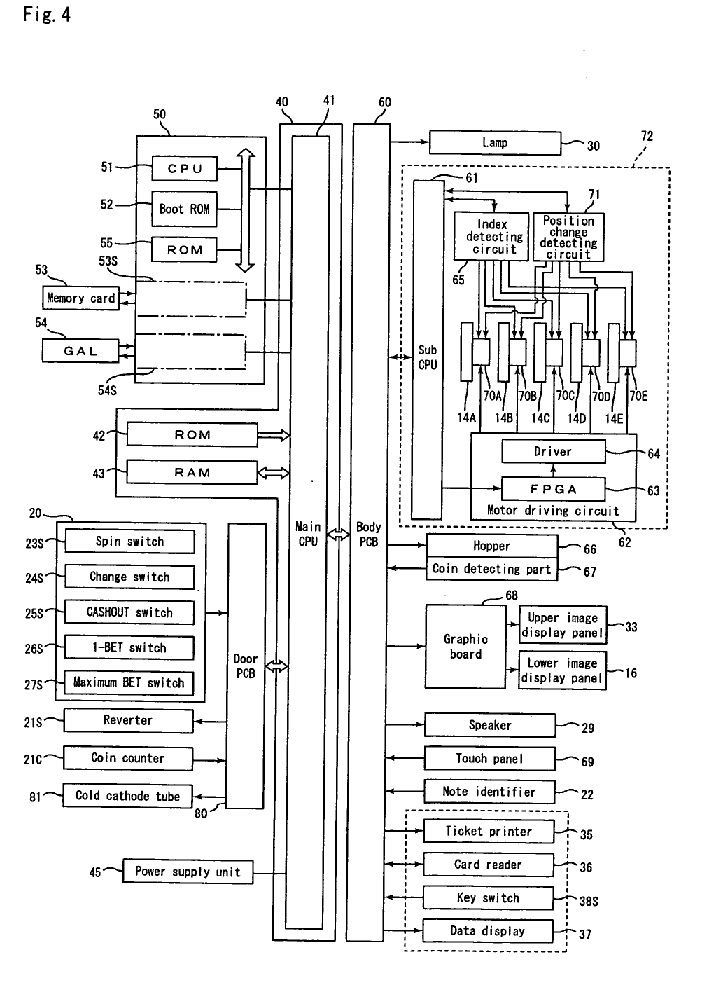

FIG. 4 is a block diagram showing the internal construction of the gaming machine shown in FIG. 2.

A gaming board 50 includes: CPU (Central Processing Unit) 51, ROM 55 and boot ROM 52 which are interconnected to one another by an internal bus; a card slot 53S which accepts a memory card 53; an IC socket 54S which accepts GAL (Generic Array Logic) 54.

The memory card 53 is constituted of non-volatile memories such as CompactFlash (registered trademark) and stores a game program. The game program contains a symbol determination program. The symbol determination program is a program for determining symbols (code Nos. corresponding to the symbols) on each of the reels 14 which are to be stop displayed in the symbol display region 28.

The card slot 53S is configured so that the memory card 53 can be inserted therein or drawn out therefrom, and connected to a mother board 40 through IDE bus. Therefore, a kind or contents of a game played in the slot machine 10 can be changed by drawing out the memory card 53 from the card slot 53S, writing a different game program thereon, and inserting the memory card 53 into the card slot 53S thereafter. The game program includes a program related to progress in a game. The game program further includes: image data and sound data output while a game is played.

CPU 51, ROM 55 and boot ROM 52 interconnected to each other by the internal bus are connected to the mother board 40 by PCI bus. The PCI bus not only conducts signal transmission between the mother board 40 and the gaming board 50, but also supplies electric power to the gaming board 50 from the mother board 40.

The mother board 40 is constructed with a general-purpose mother board commercially available (a printed circuit board on which basic parts of a personal computer are mounted) and includes: a main CPU 41; ROM (Read Only Memory) 42; RAM (Random Access Memory) 43 and a communication interface 44. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program stored on the memory card 53 is also started via the gaming board 50. In the present invention, contents of ROM 42 may be rewritable or not rewritable.

RAM 43 stores data and a program used at the time of operation of the main CPU 41. RAM 43 can store the game system program.

RAM 43 further stores data on the number of credits, the number of coin-in or coin-out for one game, and the like.

The communication interface 44 is used to communicate with the control device 200 through the communication line 101. The main CPU 41 transmits the number of coin-in and the number of coin-out together with the gaming machine identification number of the slot machine 10 to the control device 200 each time a game is played. The number of games, an accumulative number of coin-in and an accumulative number of coin-out is made to be associated with each gaming machine identification number, and stored in the control device 200. In the control device 200, a set value that is an object of comparison with the number of games is preliminary determined with respect to each gaming machine identification number, and when the number of games of one slot machine 10 reaches a set value determined for that slot machine 10, a return command signal is transmitted from the control device 200. When the main CPU 41 receives the return command signal through the communication interface 44, the return mode flag is set to the state “ON”.

Both a body PCB (Printed Circuit Board) 60 and a door PCB 80 which will be described later are connected to the mother board 40 by USB. A power supply unit 45 is also connected to the mother board 40.

Equipment and devices which generate input signals to be input to the main CPU 41, and equipment and devices of which operations are controlled by a control signal output from the main CPU 41 are connected to the body PCB 60 and the door PCB 80. The main CPU 41 executes a game program stored in RAM 43 based of an input signal input to the main CPU 41, and thereby performs a predetermined computational processing, stores results of thereof into RAM 43 and transmits a control signal to each equipment and device as a control processing for each of the equipment and devices.

A lamp 30, a reel controller 72, a hopper 66, a coin detecting section 67, a graphic board 68, a speaker 29 as an output device, a touch panel 69, a Bill validator 22, a ticket printer 35, a card reader 36, a key switch 38S and a data display 37 are connected to the body PCB 60. The lamp 30 is lit up in a predetermined pattern based on a control signal output from the main CPU 41.

The sub CPU 61 included in a reel controller 72 controls the rotation and stopping of the reels 14 (14A, 14B, 14C, 14D and 14E). A motor driving circuit 62 equipped with FPGA (Field Programmable Gate array) 63 and a driver 64 is connected to the sub CPU 61. FPGA 63 is an electronic circuit such as LSI capable of programming and works as a control circuit of a stepping motor 70. The driver 64 works as an amplifier circuit of a pulse to be input to the stepping motor 70. The stepping motors 70 (70A, 70B, 70C, 70D and 70E) which rotate each of the reels 14, are connected to the motor driving circuit 62. The stepping motor 70 is a 1-2 phase excitation type stepping motor.

An index detecting circuit 65 and a position change detecting circuit 71 are connected to the sub CPU 61. The index detecting circuit 65 is used for detecting positions (indexes described later) of the rotating reels 14 and can also detect an out-of-order state of the reels 14.

The position change detecting circuit 71 detects a change of stoppage positions of the reels 14 after the stopping of the rotating of the reels 14.

The position change detecting circuit 71 detects the change of stoppage positions of the reels 14, for example, in a case where the stoppage position is changed by force by a player as if the state of the arrangement of symbols was in a winning state, despite the fact that the state of the arrangement of symbols is not actually in a winning state, and of the like cases. The position change detecting circuit 71 is configured to be capable of detecting the change of stoppage position of the reel 14 by, for example, detecting fins (not shown in the figure) attached with a predetermined space on the inner side of the reel 14.

The hopper 66 is installed in the cabinet 11 and pays out a predetermined number of coins from a coin payout exit 19 to a coin tray 18 based on a control signal output from the main CPU 41. A coin detecting section 67 is installed inside the coin payout exit 19 and when detecting that a predetermined number of coins has been paid out from the coin payout exit 19, outputs an input signal to the main CPU 41.

The graphic board 68 controls, based on a control signal output from the main CPU 41, image displays on the upper image display panel 33 and the lower image display panel 16 as an output device. The number of credits stored in RAM 43 is displayed on the number-of-credits display section 31 of the lower image display panel 16. The number of coin-out is displayed on the number-of-payouts display section 31 of the lower image display panel 16.

The graphic board 68 is equipped with VDP (Video Display Processor) which generates image data based on a control signal output from the main CPU 41 and a video RAM which temporarily stores image data generated by VDP, and of the like equipments. Note that image data used in generating image data with VDP is read from the memory card 53 and contained in a game program stored in RAM 43.

The Bill validator 22 not only discriminates a true note from a false note, but also accepts the true note into the cabinet 11. The Bill validator 22, when accepting a true note, outputs an input signal to the main CPU 41 based on a face amount of the note. The main CPU 41 stores the number of credits corresponding to the amount of the note transmitted with the input signal.

The ticket printer 35, based on a control signal output from the main CPU 41, prints on a ticket a bar code obtained by encoding data such as the number of credits, date and time, the identification number of the slot machine 10, and of the like data stored in RAM 43, and outputs the ticket 39 with a bar code.

The card reader 36 transmits to the main CPU 41 data read from the smart card and writes data onto the smart card based on a control signal from the main CPU 41. The key switch 38S is provided on the key pad 38, and when the key pad 38 is operated by a player, outputs a predetermined input signal to the main CPU 41. The data display 37 displays, based on a control signal output from the main CPU 41, data read by the card reader 36 and data input by a player through the key pad 38.

The control panel 20, a reverter 21S, a coin counter 21C and a cold cathode tube 81 are connected to the door PCB 80. The control panel 20 is provided with a spin switch 23s corresponding to the spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by a player, each of the switches 23S to 27S corresponding thereto outputs input signals to the main CPU 41.

The coin counter 21C is installed inside the coin receiving slot 21, and discriminates whether a coin inserted by a player into the coin receiving slot 21 is true or false. Coins other than the true ones are discharged from the coin payout exit 19. The coin counter 21C also outputs an input signal to the main CPU 41 when a true coin is detected.

The reverter 21S operates based on a control signal output from the main CPU 41 and distributes coins recognized by the coin counter 21C as true coins into a cash box (not shown in the figure) or the hopper 66, which are disposed in the slot machine 10. In other words, when the hopper 66 is filled with coins, true coins are distributed into the cash box. On the other hand, when the hopper 66 is not filled with coins, true coins are distributed into the hopper 66. The cold cathode tube 81 works as a backlight installed on the back face sides of the lower image display panel 16 and the upper image display panel 33 and is lit up based on a control signal output from the main CPU 41.

Next, description will be given of a processing performed in the slot machine 10.

The main CPU 41 reads and executes the game program to such that a game is progressed.

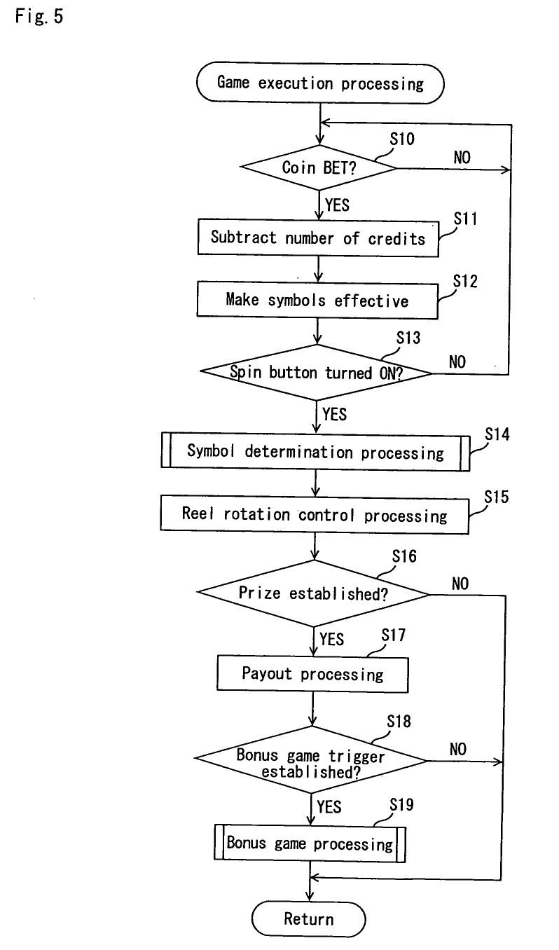

FIG. 5 is a flowchart showing a subroutine of a game execution processing.

In the game execution processing, the main CPU 41 at first determines whether or not a coin is BET (step S10). In the processing, the main CPU 41 determines whether an input signal output from the 1-BET switch 26S or the maximum BET switch 27S has been received or not when the 1-BET button 26 or the maximum BET button 27 is operated, respectively. If it is determined that a coin has not been BET, the process returns to step S10.

On the other hand, if it is determined in step S10 that a coin is BET, the main CPU 41 conducts a processing for subtracting the number of credits stored in RAM 43 according to the number of BET coins (step S11). In a case where the number of BET coins is more than the number of credits stored in RAM 43, the process returns to step S10 without conducting subtraction on the number of credits stored in RAM 43. In a case where the number of BET coins exceeds the upper limit (10 coins in the present embodiment) up to which a BET is possible in one game, the process advances to step S12 without conducting a processing for subtracting the number of BET coins from the number of credits stored in RAM 43.

Next, the main CPU 41 (the effectiveness-setting controller) makes effective a type of symbol which corresponds to the number of BETs and also causes the upper image display panel 33 to display an image indicating the symbols made effective (step S12).

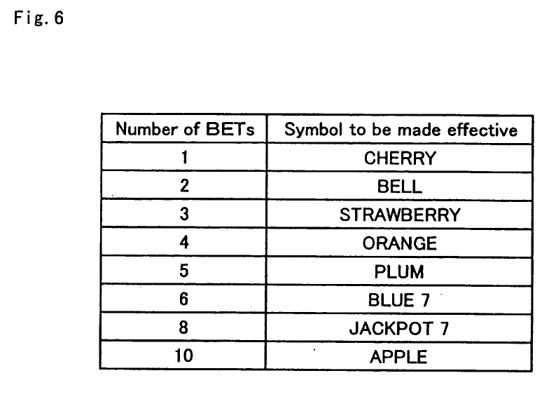

FIG. 6 illustrates relationship between the number of BETs and the corresponding types of symbols to be made effective.

As illustrated in FIG. 6, the types of symbols to be made effective are set in association with the number of BETs. For example, “CHERRY” is set in association with a number of BETs of 1, while “BELL” is set in association with a number of BETs of 2. At a step S13, if a single coin has been betted, the main CPU 41 makes “CHERRY” effective, while if two coins have been betted, the main CPU 41 makes “BELL” effective.

FIGS. 7A to 7C are views illustrating exemplary images which are displayed on the upper image display panel.

FIG. 7A illustrates an image which is displayed on the upper image display panel 33 when no coin has been betted, indicating that the symbol to be made effective is varied according to the number of BETs.

FIG. 7B illustrates an image which is displayed on the upper image display panel 33 when a single coin has been betted, wherein “1BET” and “CHERRY” are displayed in such a manner that they are distinguishable from the others. More specifically, the portions where “1BET” and “CHERRY” are displayed have a background having a different color from that of the others.

FIG. 7C illustrates an image which is displayed on the upper image display panel 33 when two coins have been betted, wherein “2BET” and “BELL” are displayed in such a manner that they are distinguishable from the others. More specifically, the portions where “2BET” and “BELL” are displayed have a background having a different color from that of the others.

While there has been described a case where the upper image display panel 33 displays images indicating the symbols which have been made effective in the present embodiment, it is also possible to provide a table designating the correspondence between the number of BETs and symbols to be made effective and direct back light to the corresponding portion thereof for indicating the symbol made effective, in the present invention.

Then, the main CPU 41 determines whether the spin button 23 has been turned ON or not (step S13). In the processing, the main CPU 41 d determines, when the spin button 23 is pressed, whether an input signal output from the spin switch 23S has been received or not.

If it is determined that the spin button 23 has not been turned ON, the process returns to step S10. Note that in a case where the spin button has not been turned ON (for example, in a case where a command of terminating a game has been input without turning ON the spin button), the main CPU 41 cancels a result of the subtracting processing in step S11.

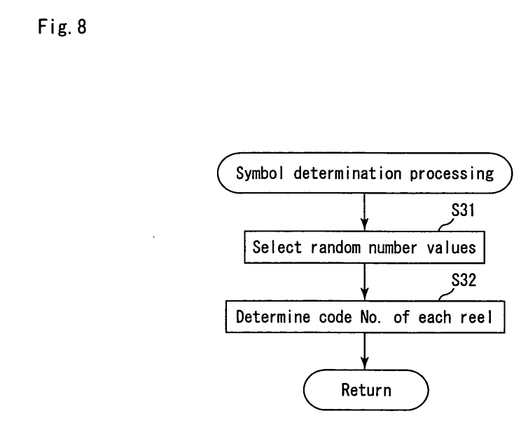

On the other hand, if the main CPU 41 determines at the step S13 that the spin button 23 has been turned on, the main CPU 41 conducts a symbol determination processing (step S14). In the symbol determination processing, the main CPU 41 executes a symbol determination program stored in the RAM 43 to determine the code Nos. at the time of stop of the respective reels 14. This processing will be described in detail later with reference to FIGS. 8 and 9. Further, in the present embodiment, there will be described a case where the types of symbols to be stop-displayed are determined for the respective reels 14 for determining the symbols to be rearranged. However, in the present invention, for example, the number of symbols of the same type to be displayed in the symbol display region (display) can be determined at first and, thereafter, on the basis of the determined number, the symbols to be stop-displayed on the respective reels can be determined to determine the symbols to be rearranged.

Next, the main CPU 41 (the arrangement controller) conducts reel-rotation control processing (step S15). This processing is processing for stopping the rotation of the respective reels, such that the symbols determined at the step S14 are stop-displayed, after the start of the rotation of all the reels 14. At this time, in the case of using a display device such as a liquid crystal display device, instead of the reels, only the effective symbols can be displayed thereon, while the portions of the ineffective symbols can be displayed as blanks. By not displaying the symbols which are not relating to payout, it is possible to make the effective symbols easily viewable.

Then, the main CPU 41 determines whether a prize has been established or not (step S16). If it is determined that a prize has been established, the main CPU 41 (the payout controller) conducts payout of a coin corresponding to the number of coin-in and the prize (step S17).

In a case where coins are reserved, the main CPU 41 conducts a processing to add the coins to the number of credits stored in RAM 43. On the other hand, in a case where payout of a coin is conducted, the main CPU 41 transmits a control signal to the hopper 66 and conducts payout of a predetermined number of coins.

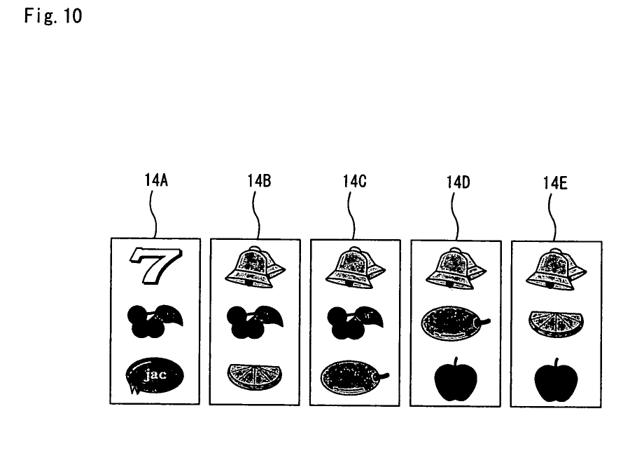

FIG. 10 is a view illustrating exemplary scatter symbols arranged on the lower image display panel in the slot machine according to the embodiment of the present invention.

As illustrated in FIG. 10, in the symbol display region 28 in the lower image display panel 16 (display), there are displayed 15 symbols including three “CHERRY” and three “BELL”.

In this case, if “CHERRY” has been made effective at the step S12, two coins, which corresponds the prize for three “CHERRY” (see FIG. 9), are paid out.

Also, in this case, if “BELL” has been made effective at the step S12, 8 coins, which corresponds to the prize for four “BELL” (see FIG. 9), are paid out.

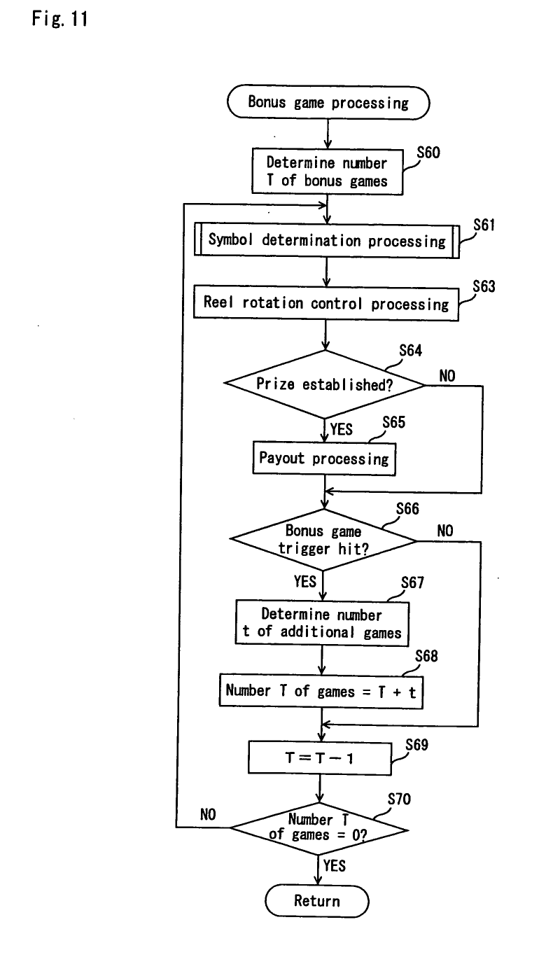

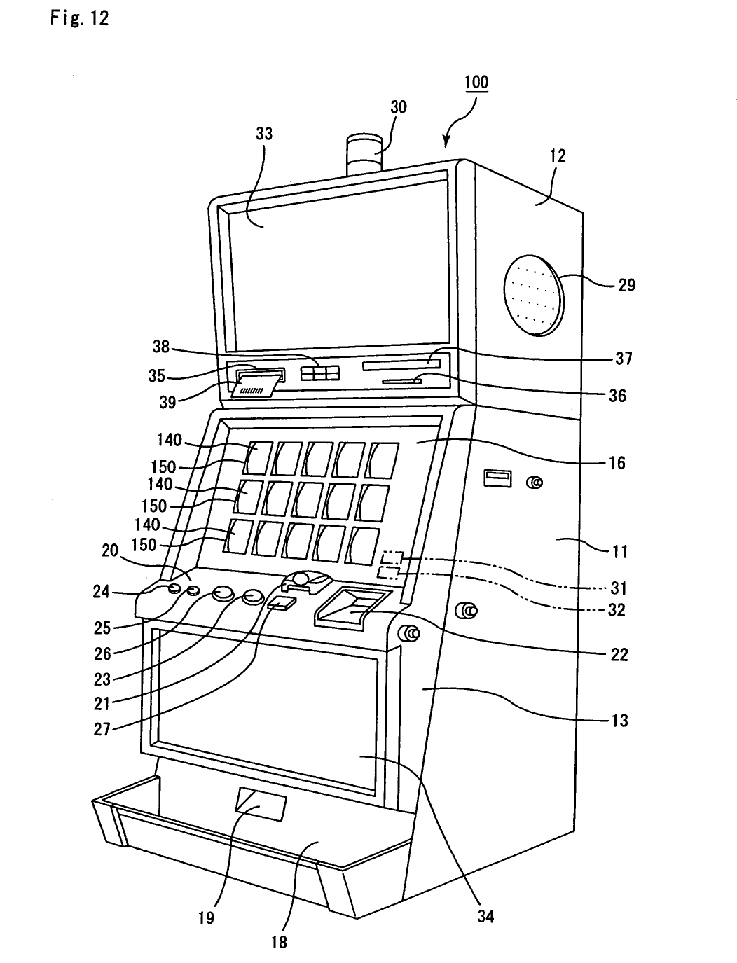

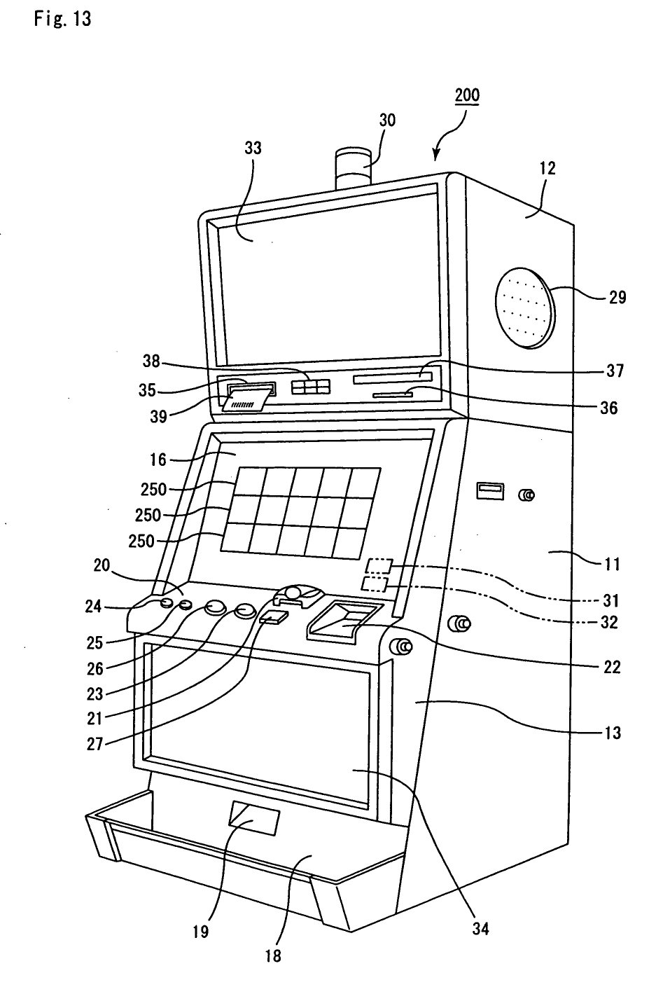

Next, the main CPU 41 determines whether or not a bonus game trigger has been established, namely whether or not five or more “APPLE” have been stop-displayed in the display windows 5 (step S18). If the main CPU 41 determines that a bonus game trigger has been established, then the main CPU 41 reads, from the RAM 43, a program for performing a bonus game and conducts bonus game processing (step S19). The bonus game processing will be described later in detail, with reference to FIG. 11.

when the main CPU 41 determined that a prize has not been established (step S16: NO) or a bonus game trigger has not been established (step S18: NO), the present subroutine is completed.

FIG. 8 is a flowchart showing a subroutine of a symbol determination processing called and executed in step S13 of the subroutine shown in FIG. 5. The processing is a processing conducted by executing a symbol determination program stored in RAM 43 with the main CPU 41. The main CPU 41 executes a random number generating program included in the symbol determination program, and a random number value from the numerical value range of 0 to 255 is selected thereby such that each of the selected random number values correspond to each of the five reels 14 (step S31). In the present embodiment, description will be given of a case where random numbers are generated on a program (a case where so-called software random numbers are used). In the present invention, however, a random number generator may be used, and random numbers may be extracted therefrom (so-called hardware random numbers may be used).

After the random number values are selected, the main CPU 41 determines, based on the selected five random number values, code Nos. (see FIG. 3) for each of the reels 14 (step S32). The code Nos. of the reels 14 correspond to code Nos. of the symbols stop displayed on center portion of display windows 15. The main CPU 41 determines code Nos. of the reels 14 to thereby determine a prize. For example, in a case where code Nos. of the reels 14 are determined “00”, “00”, “00”, “00” and “00”, it means that the main CPU 41 determined a prize as “JACKPOT”. Based on the code Nos. determined for each of the reels, a reel rotating control processing which will be described later is conducted. On this occasion, the main CPU 41 functions as winning combination determination means.

Hereinafter, there will be described prizes according to the present embodiment.

FIG. 9 is a view illustrating the relationship between plural types of prizes and the number of coins to be paid out.

If three or more symbols of the type made effective are stop-displayed in the symbol display region 28, then a corresponding number of coins illustrated in FIG. 9 are paid out.

For example, when “CHERRY” has been made effective, if three “CHERRY” are stop-displayed in the symbol display region 28, then two coins are paid out, while if four “CHERRY” are stop-displayed in the symbol display region 28, then four coins are paid out. Also, if six or more “CHERRY” are stop-displayed in the symbol display region 28, then 2*(n−2) coins are paid out. In this case, n is the number of “CHERRY” stop-displayed in the symbol display region 28.

Also, for example, when “APPLE” has been made effective, if three “APPLE” are stop-displayed in the symbol display region 28, then 50 coins are paid out, while if four “APPLE” are stop-displayed in the symbol display region 28, then 100 coins are paid out. Also, if six or more “APPLE” are stop-displayed in the symbol display region 28, then 50*(n−2) coins are paid out. In this case, n is the number of “APPLE” stop-displayed in the symbol display region 28. Further, if three or more symbols of the type made effective are not displayed in the symbol display region 28, this means no-hit and no coin is paid out.

Regardless of whether or not “APPLE” has been made effective, if five or more “APPLE” are stop-displayed in the symbol display region 28, this causes a bonus game. In a bonus game, a free game is conducted for a predetermined number of times.

FIG. 11 is a flowchart showing a subroutine of a bonus game processing called and executed in step S19 of the subroutine shown in FIG. 5. In the bonus game processing, firstly, the main CPU 41 determines a number T of bonus games from 10 to 25 games, based on a random number value obtained by executing a random number generation program included in a symbol determination program stored in RAM 43 (step S60). The main CPU 41 stores as data into RAM 43 the number of games of the determined bonus games.

Next, the main CPU 41 conducts a symbol determination processing (step S61) and a reel rotating control processing (step S63). The processing in step S61 is a processing almost the same as the processing described using FIG. 5. Since descriptions of this processing have already been given, descriptions thereof are omitted herein.

Next, the main CPU 41 determines whether or not any prize has been established (step S64). If the main CPU 41 determines that a prize has been established, the main CPU 41 pays out a number of coins which corresponds to the number of inserted coins and the prize (step S65). This processing is the same as the processing at the step S17 which has been already described and, therefore, description thereof is omitted herein.

In a case where the processing in step S65 has been executed or a prize has not been established in step S64, the main CPU 41 determines whether a bonus game trigger has been established or not, that is, whether three “APPLE” are stop displayed in the display windows 15 or not (step S66). If it is determined that the bonus game trigger has been established, the number t of additional games of the bonus game is determined in a lottery (step S67) and the determined number t of additional games is added to the number T of games of the bonus game (step S68). Thus, when a bonus game is hit during the bonus game, a remaining number of bonus games increases. More specifically, for example, in a case where a gaming state shifts to 20 bonus games for the first time, and hits 17 bonus games upon conducting 12 of the bonus games, another 25 bonus games (20 bonus games−12 bonus games+17 bonus games) are to be conducted.

In a case where a bonus game trigger has not been established in step S66 or the processing in step S68 has been executed, the main CPU 41 reads the number T of bonus games stored in RAM 43, and one bonus game is subtracted from the read number T of bonus games. The number T of bonus games after the subtraction is again stored into RAM 43 (step S69).

Then, the main CPU 41 determines whether the number T of bonus games reaches the number of games determined in step S60 or not (step S70). More specifically, it is determined whether the number T of games stored in RAM 43 has become 0 or not, and if the number T of games is not 0, that is, if it is determined that the number of bonus games played does not reach the number of games which were determined in step S60, the process returns to step S61 and the above-mentioned processing is repeated. On the other hand, if the number T of games is 0, that is, if it is determined that the number T of games has reached the number of games which were determined in step S60, the present subroutine is completed thereafter.

As described above, in the slot machine 10 and the method for playing thereof according to the present embodiment, scatter symbol is any type of symbols which are to be arranged to the lower image display panel 16. Further, with the control by the main CPU 41 (effectiveness-setting controller), for example, when the number of BETs is 1, “CHERRY” is made effective, while when the number of BETs is 2, “BELL” is made effective.

Further, with the control by the main CPU 41 (the arrangement controller), when the plural symbols arranged to the lower image display panel 16 (display) are automatically rearranged thereon, for example, if three or more “CHERRY” which have been made effective are displayed to the lower image display panel 16, then a number of coins which corresponds to the number of “CHERRY” displayed thereon (see FIG. 9) are paid out, while if three or more “BELL” which have been made effective are displayed to the lower image display panel 16, then a number of coins which corresponds to the number of “BELL” displayed thereon (see FIG. 9) are paid out.

As described above, in the slot machine 10 and the method for playing thereof according to the present embodiment, scatter symbol is any type of symbols which are to be arranged to the lower image display panel 16 and, therefore, the player is only required to check the number of scatter symbols of the type which is made effective displayed to the lower image display panel 16. This facilitates intuitive recognition of whether or not prize is established, thereby allowing anyone to easily enjoy games.

In the aforementioned example, there has been described a case where a single type of scatter symbols is made effective in association with each number of betted credits. However, in the present invention, the number of types of scatter symbols which are made effective can be increased with increasing number of betted credits, as follows. For example, when the number of BETs is 1, “CHERRY” can be made effective, while when the number of BETs is 2, “CHERRY” and “BELL” can be made effective.

With the aforementioned configuration, as the number of BETs is increased, the number of types of scatter symbols which are made effective are increased and, therefore, the probability of winning of prizes is increased. This can urge the player to consume a greater number of coins and also can cause the player to have sense of expectation.

In the aforementioned example, there has been described a case where the five mechanical reels 14 are used and three symbols are displayed on each reel 14 to display a total of 15 symbols. However, the present invention is not limited to the example, and 15 reels can be used and a single symbol can be displayed on each reel.

FIG. 12 is a perspective view illustrating an appearance of a slot machine according to another embodiment of the present invention.

The slot machine 100 has substantially the same appearance, the same circuit structure and the like as those of the slot machine 10, except of the number of reels and, further, the flow chart thereof is also substantially the same as that of the slot machine 10. Therefore, the description thereof will be omitted except the description of the reels. Further, the components corresponding to those of the slot machine 10 will be designated by the same reference characters, in the following description.

Inside of the cabinet 11 of the slot machine 100, 15 reels 140 are rotatably provided along five columns and three rows. On the outer peripheral surface of each of the reels 140, there is drawn a symbol row constituted by four symbols arranged thereon.

In the lower image display panel 16 included in the slot machine 100, there are formed 15 display windows 150 through which a back surface of the symbol display region 28 can be seen. One of the symbols drawn on an outer peripheral surface of each of the reels 140 are displayed through the corresponding display windows 150, respectively. In the case of the aforementioned configuration, the reel control portion 72 (see FIG. 4) can include 15 step motors 70 which correspond to the number of the reels. The slot machine 100 enables stop-displaying symbols of the same type along the same rows, regardless of the order of arrangement of the symbols drawn on the outer peripheral surfaces of the respective reels.

Also, in the present invention, it is possible to employ a display device such as a liquid crystal display device for displaying symbols, instead of the mechanical reels.

FIG. 13 is a perspective view illustrating an appearance of a slot machine according to further a different embodiment of the present invention.

The slot machine 200 has substantially the same appearance, the same circuit structure and the like as those of the slot machine 10, except that symbols are displayed on the lower image display panel and, further, the flow chart thereof is also substantially the same as that of the slot machine 10. Therefore, the description thereof will be omitted except the description of the display of symbols. Further, the components corresponding to those of the slot machine 10 will be designated by the same reference characters, in the following description.

In the lower image display panel 16 included in the slot machine 200, there are provided symbol display regions 250 along five columns and three rows, wherein a single symbol is displayed in each symbol display region. In the case of the aforementioned configuration, symbols can be displayed in a scrolling manner on the lower image display panel 16, instead of using the reel rotation control with the reel control portion 72 (see FIG. 4). The slot machine 200 enables increasing the ratio of symbols of the same type in the symbol rows (see FIG. 3) or changing the arrangement of the symbol rows, depending on the gaming state.

Although the embodiment according to the present invention has been described, the description presents only some of the specific examples, and is not intended to limit the present invention in any way and specific constructions of each means and the like can be properly changed in terms of design. Besides, the effects described in the embodiment of the present invention are only the most preferable effects generated from the present invention and effects to be caused by the present invention is not limited to those described in the embodiment of the present invention.

There has thus been outlined, rather broadly, the more important features of the invention in order that the detailed description thereof aforementioned may be better understood, and in order that the present contribution to the art may be better appreciated. There are, of course, additional features of the invention that described above and which formed the subject matter of the claims appended hereto.

In this respect, above explaining at least one embodiment of the invention in detail, it is to be understood that the invention is not limited in its application to the details of construction and to the arrangements of the components set forth in the aforementioned description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines maybe used with programs written in accordance with the teachings herein, or it may prove more convenient to construct more specialized apparatus to perform the required method steps. The required structure for a variety of these machines will appear from the description given.

What is claimed as new and desired to be secured by Letters Patent of the United States is:

1. A slot machine comprising:
a display to which a plurality of symbols are arranged; and
a controller which conducts a direct or an indirect paying out of a game medium, according to the number of scatter symbols displayed to said display, when the plurality of symbols arranged to said display are automatically rearranged,
wherein
said scatter symbol is any type of symbols which are to be arranged.

2. The slot machine according to claim 1,
wherein
said controller makes effective a type of scatter symbol which corresponds to the number of BETs, out of a plurality of types of scatter symbols, and
conducts the paying out of the game medium according to the number of scatter symbols of the type made effective, displayed to said display.

3. The slot machine according to claim 1,
wherein
said controller increases the number of types of scatter symbols that are made effective out of a plurality of types of scatter symbols, along with an increase in the number of BETs[Y37], and
conducts paying out of the game medium according to the number of scatter symbols of the type made effective, displayed to said display.

4. A slot machine comprising:
a display to which a plurality of symbols are arranged;
an arrangement controller which conducts control for automatically rearranging the plurality of symbols arranged to said display;
an effectiveness-setting controller which conducts control for making effective a type of scatter symbol which corresponds to the number of BETs, out of a plurality of types of scatter symbols; and
a payout controller which conducts control for conducting a direct or an indirect paying out of a game medium according to the number the type of effective scatter symbols displayed to said display, when said arrangement controller rearranges the symbols,
wherein
said scatter symbol is any type of symbols which are to be arranged.

5. A slot machine comprising:
a display to which a plurality of symbols are arranged;
an arrangement controller which conducts control for automatically rearranging the plurality of symbols arranged to said display;
an effectiveness-setting controller which conducts control for increasing the number of types of scatter symbols that are made effective out of a plurality of types of scatter symbols, along with an increase in the number of BETs; and
a payout controller which conducts control of a direct or an indirect paying out of a game medium according to the number of scatter symbols of the type made effective, displayed to said display, when said arrangement controller rearranges the symbols,
wherein
said scatter symbol is any type of symbols which are to be arranged.

6. A slot machine comprising:
a display to which a symbol matrix formed by a plurality of columns and a plurality of rows is arranged;
an arrangement controller which conducts arrangement control for selecting symbols from a plurality of types of symbols to determine the symbols to be arranged in said symbol matrix and stopping a state of scrolling at the position of the determined symbols, in order to rearrange a plurality of symbols arranged to said display as a new symbol matrix after scrolling of the plurality of symbols;
an effectiveness-setting controller which conducts control for making effective a type of scatter symbol which corresponds to the number of BETs, out of a plurality of types of scatter symbols; and
a payout controller which conducts control for conducting a direct or an indirect paying out of a game medium according to the number of scatter symbols of the type made effective, displayed to said display, when the symbol matrix is rearranged after the scrolling thereof in said display,
wherein
said scatter symbol is any type of symbols which are to be arranged.

7. A slot machine comprising:
a display to which a symbol matrix formed by a plurality of columns and a plurality of rows is arranged;
an arrangement controller which, in order to rearrange a plurality of symbols arranged to said display as a new symbol matrix after scrolling of the plurality of symbols, conducts arrangement control for selecting symbols from a plurality of types of symbols, determining the selected symbols as the symbols to be arranged in said symbol matrix and stopping the scrolling such that the determined symbols are stop-displayed;
an effectiveness-setting controller which conducts control for increasing the number of types of scatter symbols, out of a plurality of types of scatter symbols, which are made effective, with increasing number of betted credits; and
a payout controller which directly or indirectly pays out game media according to the number of scatter symbols of the type which has been made effective displayed to said display, when the symbol matrix is rearranged after the scrolling thereof in said display,
wherein
said scatter symbol is any type of symbols which are to be arranged.

8. A playing method of a slot machine comprising:
a step of conducting a direct or an indirect paying out of a game medium according to the number of scatter symbols displayed to a display when a plurality of symbols arranged to said display are automatically rearranged,
wherein
said scatter symbol is any type of symbols which are to be arranged.

9. The playing method of a slot machine according to claim 8,
further comprising:
a step of making effective a type of scatter symbol which corresponds to the number of BETs, out of a plurality of types of scatter symbols,
wherein
said step of conducting the paying out includes the paying out of the game medium according to the number of scatter symbols of the type made effective, displayed to said display.

10. The playing method of a slot machine according to claim 8,
further comprising:
a step of increasing the number of types of scatter symbols that are made effective out of a plurality of types of scatter symbols, along with an increase in the number of BETS, wherein
said step of conducting the paying out includes the paying out of the game medium according to the number of scatter symbols of the type made effective, displayed to said display.

11. A playing method of a slot machine
comprising the steps of:
rearranging automatically a plurality of symbols arranged to a display;
making a type of scatter symbols which corresponds to the number of BETs, out of a plurality of types of scatter symbols, effective; and
paying out a game medium directly or indirectly, according to the number of scatter symbols of the type made effective, displayed to said display, when the symbols are rearranged,
wherein
said scatter symbol is any type of symbols which are to be arranged.

12. A playing method of a slot machine
comprising the step of:
rearranging automatically a plurality of symbols arranged to a display;
increasing the number of types of scatter symbols, out of a plurality of types of scatter symbols, which are made effective, with increasing number of betted credits; and
paying out a gaming medium directly or indirectly, according to the number of scatter symbols of the type made effective, displayed to said display, when the symbols are rearranged,
wherein
said scatter symbol is any type of symbols which are to be arranged.

13. A playing method of a slot machine which repeats a unit game that is started by starting scrolling display of a plurality of symbols arranged to a display and is completed by stopping the scrolling display to rearrange said plurality of symbols,
comprising the step of:
stopping automatically said scrolling display of the symbols;
making a type of scatter symbols which corresponds to the number of BETs, out of a plurality of types of scatter symbols, effective; and
paying out a game medium directly or indirectly, according to the number of scatter symbols of the type made effective, displayed to said display, when the scrolling display of the symbols are automatically stopped,
wherein
said scatter symbol is any type of symbols which are to be arranged.

14. A playing method of a slot machine which repeats a unit game that is started by starting scrolling display of a plurality of symbols arranged to a display and is completed by stopping the scrolling display to rearrange said plurality of symbols,
comprising the step of:
stopping automatically the scrolling display of the symbols;
increasing the number of types of scatter symbols, out of a plurality of types of scatter symbols, which are made effective, with increasing number of betted credits; and
paying out game media directly or indirectly, according to the number of scatter symbols of the type made effective, displayed to said display, when the scrolling display of the symbols are automatically stopped,
wherein
said scatter symbol is any type of symbols which are to be arranged.
